(19) United States
(12) Patent Application Publication
(10) Pub. No.: US 2002/0112111 A1
(43) Pub. Date: Aug. 15, 2002

(54) Parallel and point-to-point data bus architecture

(76) Inventors: Patrick Joseph Zabinski, Stewartville, MN (US); Michael John Degerstrom, Rochester, MN (US); Barry K. Gilbert, Rochester, MN (US)

Correspondence Address: Walter C. Linder, FAEGRE & BENSON LLP, 2200 Wells Fargo Center, 90 South Seventh Street, Minneapolis, MN, 55402-3901, US

(21) Appl. No.: 09/780,147

(22) Filed: Feb. 9, 2001

(51) Int. Cl. G06F 13/00

(52) U.S. Cl. 710/317

(57) ABSTRACT

A parallel, point-to-point bus architecture for interconnecting two or more electronic components for data communication. The bus architecture includes a non-blocking crosspoint switch having a tap for interconnection to each component, a clock terminal for receiving a common clock signal and an interface for connecting each component to a tap of the crosspoint switch. Each interface includes parallel data terminals for coupling data signals between the crosspoint switch tap and the component, a clock terminal for coupling the common clock signal between the crosspoint switch tap and the component and a clock-to-data alignment system. The clock-to-data alignment system aligns the data signals coupled between the crosspoint switch tap and the component to the common clock signal. Simultaneous data communications at very high speeds can be achieved through use of the bus.

### REFERENCE TO RELATED APPLICATIONS

Reference is hereby made to the following commonly assigned applications filed on even date herewith:

1. U.S. application Ser. No.______ entitled Self-Terminating Current Mirror Transceiver Logic

2. U.S. application Ser. No.______ entitled Performance Enhanced Leaded Packaging For Electrical Components.

3. U.S. application Ser. No.______ entitled Data Bit-To-Clock Alignment Circuit With First Bit Capture Capability

### BACKGROUND OF THE INVENTION

1. Field of the Invention

The present invention relates to parallel data buses for interconnecting electronic components or peripherals for data communications.

2. Description of the Related Art

Serial and parallel buses are used in electronic systems such as computers to interconnect microprocessors, memory, input/output devices, printers and other electronic components or peripherals for digital data communication. Serial data buses include a single transmission line over which the digital data signals are transmitted sequentially (i.e., one bit at a time). Widely used serial data bus architectures and standards include RS-232 and RS-486. Since the data is transmitted serially, the data transfer capacity of serial buses is generally limited. In addition, these buses generally rely on data transfer through successive components which limits their usefulness in applications requiring data communications between three or more components.

Parallel data buses are generally capable of higher data transfer capacity than serial buses since multiple bits are simultaneously transmitted over several parallel transmission lines (i.e., n bits at a time where n is equal to the number of transmission lines). Known parallel bus architectures and standards include Rambus and PCI (personal computer interface). Parallel buses of these types are also subject to certain limitations. When used to interconnect three or more components, performance limiting stubs are typically needed to interconnect at least one of the components to the transmission line. Furthermore, the so-called “blocking architectures” of many of these buses do not permit multiple simultaneous communications.

The development of data bus architectures and related standards has generally lagged the continuing increases in the operating speed of the microprocessors and other electronic components that they are used to interconnect. As a result, data buses can be the performance limiting feature in certain electronic systems. There is, therefore, a continuing need for improved data buses. In particular, there is a need for a high speed parallel data bus architecture capable of transmitting data at the rates at which it can be used and processed by the electronic components of the system. A bus having these characteristics which can support multiple simultaneous communications (i.e., a non-blocking architecture) would be especially desirable. To be commercially viable, any such bus architecture should be capable of being efficiently implemented.

### SUMMARY OF THE INVENTION

The present invention is a parallel, point-to-point bus architecture which can support simultaneous high speed data communications between two or more electronic systems. One embodiment of the bus includes a non-blocking crosspoint switch having a tap for interconnection to each component; a clock terminal for receiving a common clock signal and an interface for connecting each component to a tap of the crosspoint switch. Each interface includes parallel data terminals for coupling data signals between the crosspoint switch tap and the component, a clock terminal for coupling the common clock signal between the crosspoint switch tap and the component and a clock-to-data alignment system. The clock-to-data alignment system time aligns the data signals coupled between the crosspoint switch tap and the component to the common clock signal.

### BRIEF DESCRIPTION OF THE DRAWINGS

FIG. 1 is a block diagram of a parallel data bus in accordance with the present invention interconnecting a plurality of electronic components.

FIG. 2 is a detailed schematic and block diagram of the interface between the crosspoint switch and processor shown in FIG. 1.

FIG. 3 is a detailed schematic and block diagram of the interface between the crosspoint switch and memory shown in FIG. 1.

FIG. 4 is a detailed schematic and block diagram of the interface between the crosspoint switch and mass storage shown in FIG. 1.

FIG. 5 is an illustration of an exemplary digital Data signal and associated eye diagram, and several Clock signals at different phase relationships to the eye diagram, presented for use in connection with the descriptions of the data bit alignment circuits described with reference to FIGS. 6-11.

FIG. 6 is a block diagram of a data bit alignment circuit which can be incorporated into the parallel data bus of the present invention.

FIG. 7 is a schematic diagram of an exemplary embodiment of the Data signal delay and sampling circuits shown in FIG. 6.

FIG. 8 is a schematic diagram of an exemplary embodiment of the sample comparator circuit shown in FIG. 6.

FIG. 9 is a schematic diagram of an exemplary embodiment of the decision circuit shown in FIG. 6.

FIG. 10 is a schematic diagram of an exemplary embodiment of the first-bit initialization circuit shown in FIG. 6.

FIG. 11 is a schematic diagram of an alternative embodiment of the first-bit initialization circuit shown in FIG. 6.

### DETAILED DESCRIPTION OF THE PREFERRED EMBODIMENTS

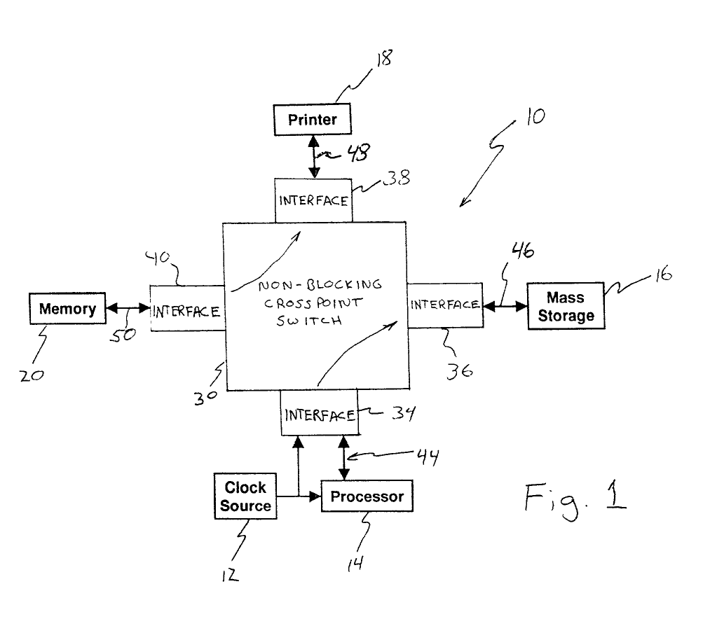

A parallel, point-to-point data bus 10 in accordance with the present invention is illustrated generally in FIG. 1. In the application shown, bus 10 interconnects a clock source 12, microprocessor 14, mass storage (e.g., disk drive) 16, printer 18 and memory (e.g., RAM) 20, all of which can, for example, be electronic components or peripherals of a personal computer. Data bus 10 includes a non-blocking crosspoint switch 30 having a tap for each of the electronic components to be interconnected for data communication (i.e., four in the embodiment shown in FIG. 1) and interfaces 34, 36, 38 and 40 associated with the respective taps. Clock source 12 is connected to the data bus 10 through interface 34 in the embodiment, shown, although in alternative embodiments (not shown) it can be interconnected through a different interface or a separate tap and/or interface. Interfaces 34, 36, 38 and 40 are connected to the respective electronic components 14, 16, 18 and 20 through parallel buses 44, 46, 48 and 50. As described in greater detail below, bus 10 enables simultaneous data communications at rates in excess of 1 gigabit/second (Gbps) per bus bit width between two or more of the electronic components such as 14, 16, 18 and 20 to which it is interconnected. For example, at the same time that data is being transferred from the memory 20 to the printer 18 through the bus 10, data can also be transferred from the microprocessor 14 to the mass storage 16. Both of these data signal transfers can occur at high data rates.

Non-blocking crosspoint switches such as 30 are well known and disclosed, for example, in the LaRue U.S. Pat. No. 5,777,505. Briefly, when incorporated into the illustrated embodiment of bus 10, a crosspoint switch 30 of the type shown in the LaRue U.S. patent can include four multiplexers (i.e., one associated with each tap, but not shown) and control logic (also not shown). All of the multiplexers have a parallel associated interface port connected to receive data from and/or transmit data to the associated interface 34, 36, 38, and 40, and plurality of parallel non-associated interface ports. Each of the non-associated interface ports is connected to receive data from and/or transmit data to each of the other or non-associated interfaces 34, 26, 38 and 40. In response to routing control signals, the control logic causes the multiplexers to route data between the associated interface port and a selected one or more of the non-associated interface ports. The routing control signals are typically provided by one of the electronic components such as the microprocessor 14, although a separate bus routing control system (not shown) can also be used for this function. Any of a wide variety of known or otherwise available crosspoint switches 30 can be used in connection with bus 10.

Parallel buses 44, 46, 48 and 50 are typically n bits wide, where n is equal to the width (e.g., often 8, 16 or 32 bits) of the data signals communicated between the electronic components such as 14, 16, 18 and 20. An additional signal path is used to transmit the common clock signal between the source 12 and the interfaces 34, 36, 38, and 40 and the electronic components such as 14, 16, 18 and 20.

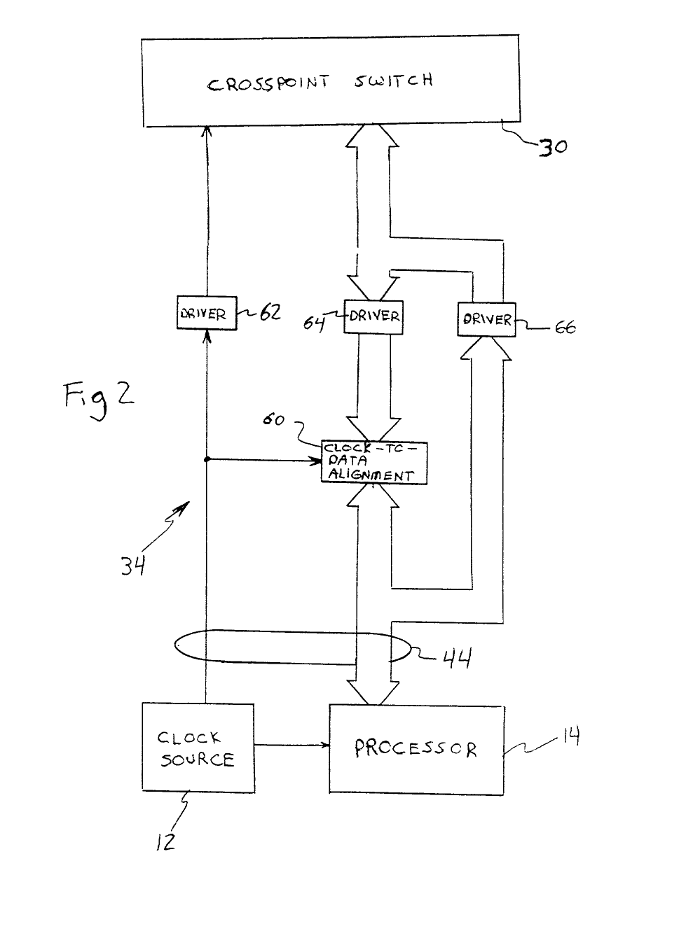

FIG. 2 is a detailed schematic and block diagram of the interface 34 and its interconnections to the associated tap of the crosspoint switch 30 and the processor 14 and clock source 12. The interface 34 includes clock-to-data alignment system 60 and drivers 62, 64 and 66. Data from microprocessor 14 is transmitted to crosspoint switch 30 through driver 66, while data from the crosspoint switch is transmitted to the processor through the driver 64 and the clock-to-data alignment system 60. The clock signal from the clock source 12 is coupled directly to the processor 14 and clock-to-data alignment system 60, and to the crosspoint switch through the driver 62. Drivers 62, 64 and 66 (also known as digital receivers and transmitters, transceivers or buffers) can be configured in any of a variety of known or otherwise available arrangements suitable for the characteristics of the logic signals being transmitted over the bus 10 and the characteristics of the bus and electronic components 14, 16, 18 and 20. Drivers of the type described in the patent application entitled Self-Terminating Current Mirror Transceiver Logic and referred to above in the cross reference section can, for example, be used. Other embodiments of the invention (not shown) may not require drivers such as 62, 64 and 66 if the clock source 12, processor 14 and alignment system 60 are directly compatible with the switch 30.

As described in greater detail below, bus 10 effectively operates in a pseudo-asynchronous mode. Clock-to-data alignment system 60 synchronizes the data signals received from the crosspoint switch 30 to the clock signal received from the clock source 12 before transmitting the data signals on to the processor 14 for sampling. The data signals transmitted from the processor 14 to the other electronic components 16, 18 and 20 over the bus 10 need not be processed by the clock-to-data alignment system 60.

Clock-to-data alignment system 60 aligns the bits of the data signals transmitted over bus 44 to the clock signal received from source 12. This alignment function is performed to reduce transmission line-induced and component-induced phase drifts between the clock and data signals, and thereby enhance the accuracy of the data signal sampling and recovery. Clock-to-data alignment systems such as 60 are known and disclosed, for example, in the Pawelski U.S. Pat. No. 5,822,386 and the Rettberg et al. U.S. Pat. No. 4,700,347. However, the clock-to-data alignment system 60 can be configured in any of a variety of known or otherwise available arrangements using either hardware or software. One embodiment of the bus 10 includes a clock-to-data alignment system with first bit recovery capabilities of the type referred to above in the cross reference section and described in detail below.

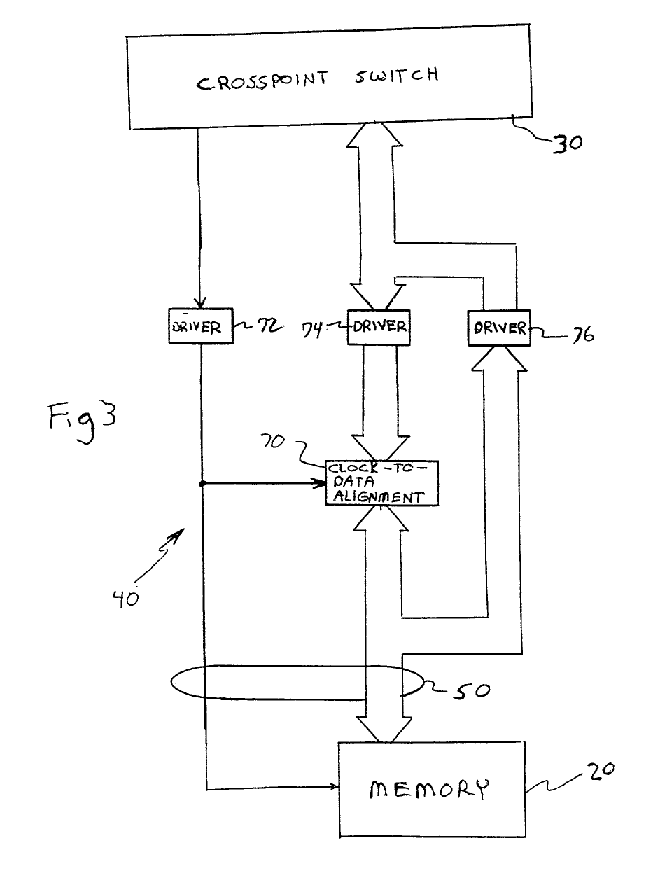

FIG. 3 is a detailed schematic and block diagram of the interface 40 and its interconnections to the associated tap of the crosspoint switch 30 and the memory 20 (e.g., synchronous RAM). The interface 40 includes clock-to-data alignment system 70 and drivers 72, 74 and 76. Data from memory 20 is transmitted to crosspoint switch 30 through driver 76, while data from the crosspoint switch is transmitted to the memory through the driver 74 and the clock-to-data alignment system 70. The clock signal received from the clock source 12 through the crosspoint switch 30 is coupled to the memory 20 and clock-to-data alignment system 70, and to the crosspoint switch through the driver 72. Clock-to-data alignment system 70 and drivers 72, 74 and 76 can be identical to their counterparts in interface 34 described above, and perform similar functions.

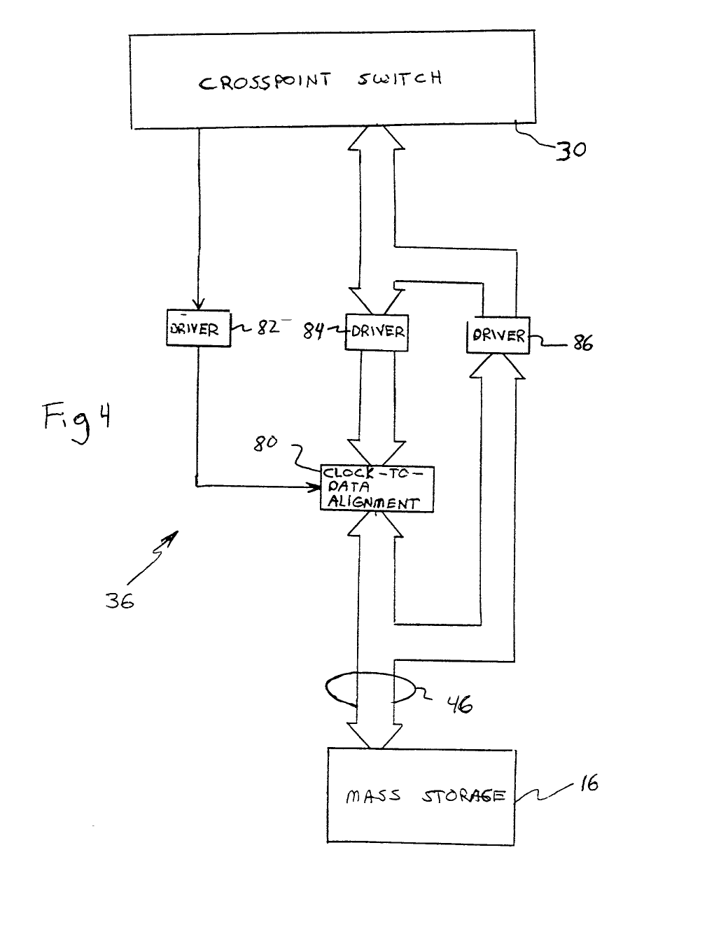

FIG. 4 is a detailed schematic and block diagram of the interface 36 and its interconnections to the associated tap of the crosspoint switch 30 and the mass storage 16 (e.g., an input/output device). The interface 36 includes clock-to-data alignment system 80 and drivers 82, 84 and 86. Data from mass storage 16 is transmitted to crosspoint switch 30 through driver 86 while the data from the crosspoint switch is transmitted to the mass storage through the driver 84 and the clock-to-data alignment system 80. The clock signal received from the clock source 12 through the crosspoint switch 30 is coupled to the clock-to-data alignment system 80 through the driver 72. Clock-to-data alignment system 80 and drivers 82, 84 and 86 can be identical to their counterparts in interface 34 described above, and perform similar functions. Although not shown in detail, interface 38 to printer 18 and interfaces to other electronic components can be configured similar to interfaces 34, 40 and 36, with a clock-to-data alignment circuit connected to receive the clock signal from source 12.

Bus 10 provides pseudo-asynchronous data communications between the electronic components such as 14, 16, 18 and 20 to which it is interfaced. Data signals are transmitted over the bus 10 at a bit rate corresponding to the frequency of clock source 12 (or an integer fraction thereof). However, the data signals are not required to be phase synchronized or time aligned with the clock signal. Propagation delays in the clock signal over the bus 10, as well as differences in the propagation delays between the clock signal and the data signals (i.e., phase differences) arriving at an interface 34, 36, 38 and 40 are compensated by the clock-to-data alignment system such as 60, 70 and 80 in the associated interface. The clock signal generated by source 12 is a common clock signal which functions as a bus frequency reference and is distributed to and used by all the interfaces 34, 36, 38 and 40 of bus 10. In effect, time alignment of the clock signal from source 12 is not critical, but the same clock frequency must be applied to all the interfaces 34, 36, 38 and 40, and the associated components 14, 16, 18 and 20 as needed.

In operation, synchronization between the data signals transmitted between components 14, 16, 18 and 20 is achieved by the clock-to-data alignment system such as 60, 70 and 80 in the associated interface 34, 36, 38 and 40. The clock-to-data alignment systems 60, 70 and 80 utilize the common clock signal from source 12 to perform real time alignment of the incoming data signal bits to enable sampling of the data signal bits at optimal points in time. No relative phase alignment of the incoming clock signal and data signals are therefore required. Bus 10 is therefore insensitive to differential phase delays in both the clock signal and data signals transmitted to the electronic components 14, 16, 18 and 20.

Use of the clock-to-data bit alignment circuit described below enables the recovery of the first bit of information in the data signals transmitted over the bus 10. The loss of data, or the need for special data formats, can therefore be avoided.

Handshaking protocols transmitted over the bus 10 between the electronic components 14, 16, 18 and 20 interconnected for data communications include information which establishes which of the electronic components are to be connected and when the connection is to be terminated. The handshaking protocol also controls the crosspoint switch 30. Examples of crosspoint switch control functions provided by the handshaking protocol include causing the data signals to be routed between the desired interfaces 34, 36, 38 and 40, controlling priority over transmissions between the electronic components 14, 16, 18 and 20 and overall control of bus 10. In the embodiment of the invention which uses the clock-to-data alignment system described below with first bit recovery capabilities, a start signal (i.e., the first bit trigger) that is transmitted through the crosspoint switch 30 with the data signal is incorporated into the handshaking protocol. Any of a wide variety of known or otherwise available handshaking protocols suitable for the particular application in which the bus 10 is incorporated can also be used.

Although the interfaces 34, 36, 38 and 40 are shown interconnected to the associated taps of the crosspoint switch 30, the interfaces could alternatively be incorporated into the respective electronic components 14, 16, 18 and 20, and the interface connected to the crosspoint switch by buses 44, 46, 48 and 50. In other alternative implementations of bus 10 (not shown), two or more crosspoint switches are connected to one another through taps and associated interfaces such as 34, 36, 38 and 40, and the other taps on the switches are connected to electronic components through the interfaces. In effect, bus 10 can be expanded to interconnect any desired number of electronic components such as 14, 16, 18 and 20.

Bus 10 offers a number of important advantages. Perhaps most importantly, it enables high data rate signal transmission. One or more data signals can be transmitted simultaneously in a point-to-point arrangement. When used in an application with a microprocessor or other processing unit, for example, effective communications can be achieved without limiting the performance of the microprocessor. The bus architecture can also be efficiently implemented. By way of example, when bus 10 is used in a 32 bit wide application at a 2 Gbps/channel transmission rate with eight peripherals and four simultaneous communications, a system data rate of 256 Gbps can be achieved.

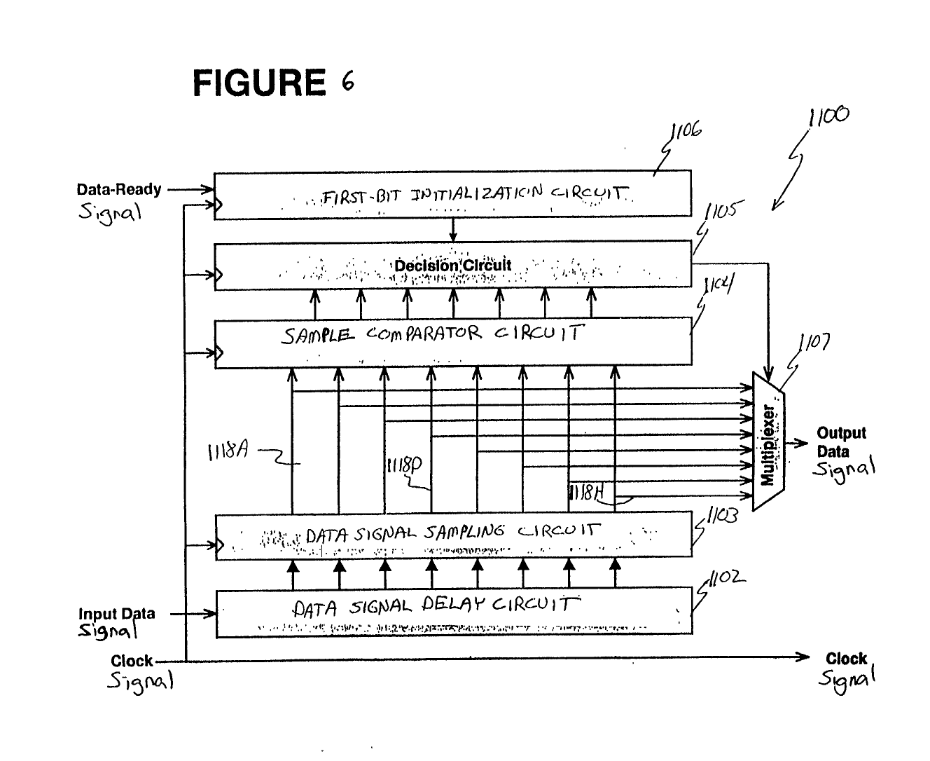

A data bit alignment circuit 1100 which can be incorporated into the parallel data bus of the present invention is illustrated generally in FIG. 6. The circuit 1100 is used to align or synchronize the relative phase of two signals such as a Clock signal and a digital Data signal. As shown, the data bit alignment circuit 1100 includes a data signal delay circuit 1102, data signal sampling circuit 1103, sample comparator circuit 1104, decision circuit 1105, first-bit initialization circuit 1106 and multiplexer 1107. The Clock signal is applied to the Data signal sampling circuit 1103, sample comparator circuit 1104, decision circuit 1105 and first-bit initialization circuit 1106. The digital Data signal (i.e., a stream of bits) to be phase-aligned to the Clock signal is applied to the data signal delay circuit 1102. Alignment circuit 1100 also makes use of a Data Ready signal which enables the circuit to align the first bit of the Data signal to the Clock signal. As is described in greater detail below, the alignment circuit 1100 can quickly (even on the first bit) and accurately synchronize a digital Data signal to a Clock signal. The circuit can maintain this accurate synchronization in the presence of phase drift between the Clock and Data signals.

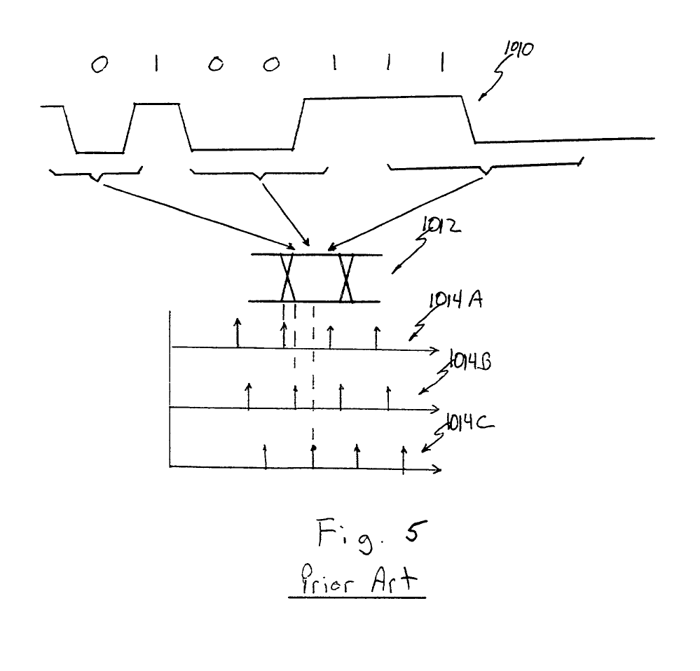

Briefly, the incoming Data signal is effectively delayed by the delay circuit 1102, enabling each bit of the Data signal to be sampled at several (N) locations by the sampling circuit 1103. Each of the bit samples is applied to both the comparator circuit 1104 and the multiplexer 1107. The comparator circuit 1104 compares the adjacent bit samples and provides “sameness” or comparison data signals to the decision circuit 1105 which are representative of whether the adjacent bit samples have the same or different logic states. In effect, the comparison data is characteristic of whether the Data signal bit switched logic states at the point in time corresponding to the sample (i.e., whether the bit sample was taken at a point in time corresponding to the transition region or stable region in the eye diagram 12 (FIG. 5)). The decision circuit 1105 processes the comparison data signals on the basis of a decision algorithm to determine which of the Data signal bit samples was taken at a point in time corresponding to the stable region of the eye diagram 12 (e.g., was the most “same”). The output of the decision circuit 1105 is a sample select signal which causes the multiplexer 1107 to output the selected Data signal bit sample as the sample which is aligned with the Clock signal (i.e., the phase-aligned Data signal). The Data Ready signal, which provides an initial-bit control function, is a signal which switches logic states at a time corresponding to the beginning of the first bit of a “new” Data signal. In response to the receipt of a Data Ready signal, the first-bit initialization circuit 1106 causes the decision circuit 1105 and multiplexer 1107 to select the Data signal bit sample which corresponds in time to the logic level transition of the Data Ready signal as the first Data signal bit sample of the phase-aligned Data signal outputted by the multiplexer 1107.

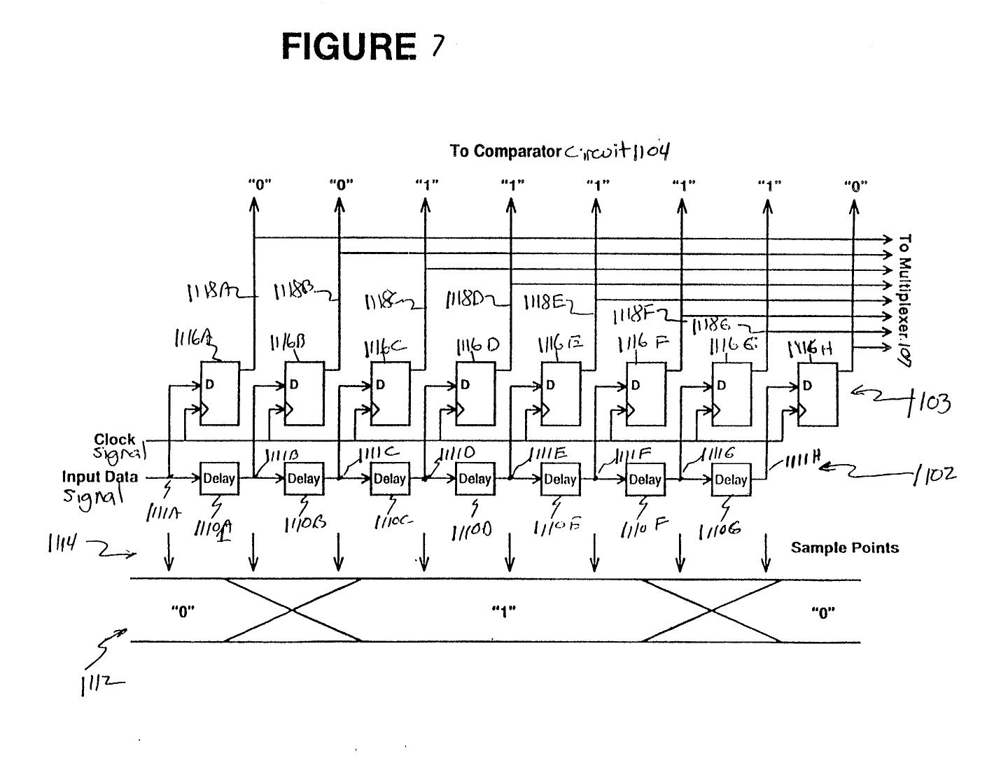

The operation of data signal delay circuit 1102 and data signal sampling circuit 1103 can be described in greater detail with reference to FIG. 7. In the embodiment shown, the delay circuit 1102 is formed by a plurality of series-interconnected delay elements 1110A-1110G which effectively divide the incoming Data signal into N sections, where N is an integer greater than 1. The original (not delayed) Data signal (at node 1111A) and the delayed Data signals present at the output of each of the elements 1110A-1110G (nodes 1111B-1111H, respectively) are simultaneously applied to the sampling circuit 1103. Although the illustrated embodiment of the delay circuit 1102 includes seven delay elements 1110A-1110G configured for N−δ, any desired number of delay elements can be used. In general, the delay elements 1110A-1110G will be configured to delay the Data signal by time periods which are considerably less than the period of the bits of the Data signal to provide several samples from each bit. The desired number of delay elements will typically be selected on the basis of a variety of factors including the desired degree of accuracy or resolution to be achieved by the alignment circuit 1100 and the period or length of the bits of the Data signal. The amount of delay imparted to the Data signal by each element 1110A-1110G can also be selected on the basis of a variety of factors including the number of delay elements and the accuracy to be achieved by the data alignment circuit 1100. The delay provided by the elements 1110A-1110G need not all be equal. Typically, the delay elements 1110A-1110G will all exhibit equal delay with the total delay through the circuit 1102 being slightly longer than the period of one bit of the Data signal.

The sampling circuit 1103 is formed by flip-flops 1116A-1116H in the embodiment shown in FIG. 6. The data (“D”) input terminal of the flip-flops 1116A-1116H are connected to receive the original and delayed Data signals present at the nodes 1111A-1111H, respectively. The clock input terminals of the flip-flops 1116A-1116H are all connected to simultaneously receive the Clock signal. This circuit configuration causes the output terminals 1118A-1118H of the flip-flops 1116A-1116H to provide bit sample signals representative of the logic state of the original and delayed Data signals present at the respective data input terminals. In effect, the bit sample signals at the output terminals 1118A-1118H are N time-slice samples over a sampling region (i.e., a predetermined length) of the Data signal.

For purposes of illustration, an example of a Data signal eye diagram 1112 and Clock signal 1114 which are graphically “scaled” to the delay elements 1110A-1110G is shown in FIG. 7. In this example all the elements 1110A-1110G provide the same amount of delay, and the sampling region is slightly (i.e., between one and two Clock signal periods) greater than the period of the Data signal bits. Eight time-slice bit samples are therefore provided for each sequential and adjacent sampling region of the Data signal, with each bit of the Data signal being sampled about six or seven times.

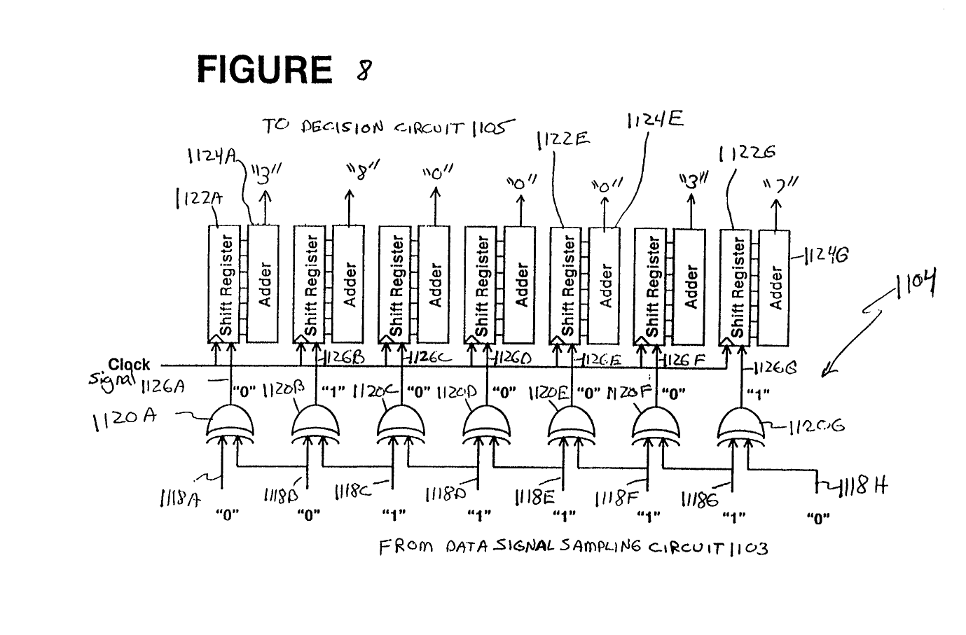

The operation of the sample comparator circuit 1104 can be described in greater detail with reference to FIG. 8. In the embodiment shown, the comparator circuit 1104 includes Exclusive Or logic gates 1120A-1120G, shift registers 1122A-1122G and adders 1124A 1124G. Each logic gate 1120A-1120G is connected to two adjacent flip-flop output terminals 1118A-1118H to receive as input signals the associated two adjacent time-slice bit samples. Gate 1120A, for example, is connected to terminals 1118A and 1118B, and gate 1120B is connected to terminals 1118B and 1118C. The output terminals 1126A-1126G of the gates 1120A-1120G are connected to the inputs of the shift registers 1122A-1122G, respectively. The clock input terminals of the shift registers 1122A-1122G are all connected to simultaneously receive the Clock signal. Adders 1124A-1124G are connected to the respective shift registers 1122A-1122G.

Comparator circuit 1104 compares the adjacent bit samples on terminals 1118A-1118H and maintains a running summary of the comparisons. The comparisons are made by the logic gates 1120A-1120G, which provide comparison data signals representative of whether the adjacent time-slice bit samples have the same or different logic states. If the adjacent bit samples are the same, they were sampled at time slices during which the logic state of the Data signal remained constant, and indicate that the clock pulses are generally synchronized with the stable region of the Data signal eye diagram 1012 (FIG. 5). If on the other hand the adjacent time-slice bit samples are different, they were sampled at time slices during which the logic state of the Data signal changed, and indicate that the clock pulses are generally aligned with the transition region of the Data signal eye diagram 1012. In the particular circuit embodiment shown, a logic “0” will be present at the output of the logic gates 1120A-1120G which compared adjacent time-slice bit samples which are the same, and a logic “1” will be present at the output of the logic gates which compared adjacent bit samples which are different.

The comparison data on each terminal 1126A-1126G is sequentially shifted through the associated shift register 1122A-1122G with each Clock signal pulses applied to the shift registers. The shift registers 1122A-1122G, which can be any desired number M bits long, thereby maintains a running record of the comparison data of each time-slice for the preceding or last M samples. Adders 1124A-1124G add the M comparison data in the associated shift registers 1122A-1122G to provide comparison data sums. The comparison data sums are in effect equal to the number of logic “1s” present in the associated shift registers 1122A-1122G. When the Data signal has relatively good signal integrity (and therefore a clean eye diagram), the comparison data sums generated by comparator circuit 1104 can be used to accurately identify the time slices within the Data signal bit period at which the signal is in the stable region. In the example shown in FIG. 8, adders 1124A, 1124B, 1124F and 1124G all have comparison data sums between three and eight, indicating that the time slices of the Data signal sampled at nodes 1111B, 1111C, 1111G and 1111H, respectively, occur during the transition region. Adders 1124C-1124E, on the other hand, all have comparison data sums equal to zero, indicating that the time slices of the Data signal sampled at nodes 1111D-1111F, respectively, occur during the stable region. By maintaining a record of the last M comparison data for each time slice, the comparator circuit 1104 is able to effectively average out the effects of M bits of the Data signal. Furthermore, by maintaining the record as a running total, the circuit 1104 is able to track and appropriately adjust to relative Clock-signal-Data signal phase shifts over time.

The function of the decision circuit 1105 is to process the comparison data sums generated by the comparator circuit 1104 for the purpose of determining which of the flip-flop output terminals 1118A-1118H is providing the most stable time-slice bit samples. In particular, the comparison data sums are examined on the basis of a predetermined decision logic algorithm to determine the most stable time-splice bit samples. After the most stable bit sample is identified, the decision circuit 1105 generates a sample select signal representative of the selected time-slice bit sample. The sample select signal is transmitted to and used by the multiplexer 1107 to select the flip-flop output terminal 1118A-1118H associated with the optimum time-slice bit sample signal which is to be outputted as the synchronized Data signal.

By way of example, in one embodiment of the invention the decision circuit 1105 implements a decision algorithm which selects as the most stable time-slice bit sample the sample at which: 1) the adjacent previous, selected, and adjacent next time-slice bit samples all have comparison data sums equal to zero (i.e., the selected time-slice location has been in the stable region during the previous M clock pulse cycles and must be between locations which have been in the stable region during the previous M clock pulse cycles), 2) any of the adjacent previous, selected, and adjacent next time-slice bit samples was the selected time-slice bit sample during the immediately previous Clock signal period (i.e., the selected location cannot move more than one delay period during a clock pulse period), and 3) the comparison data sum in the time-slice bit sample location two sample locations later in time (i.e., two delay periods) is a non-zero value.

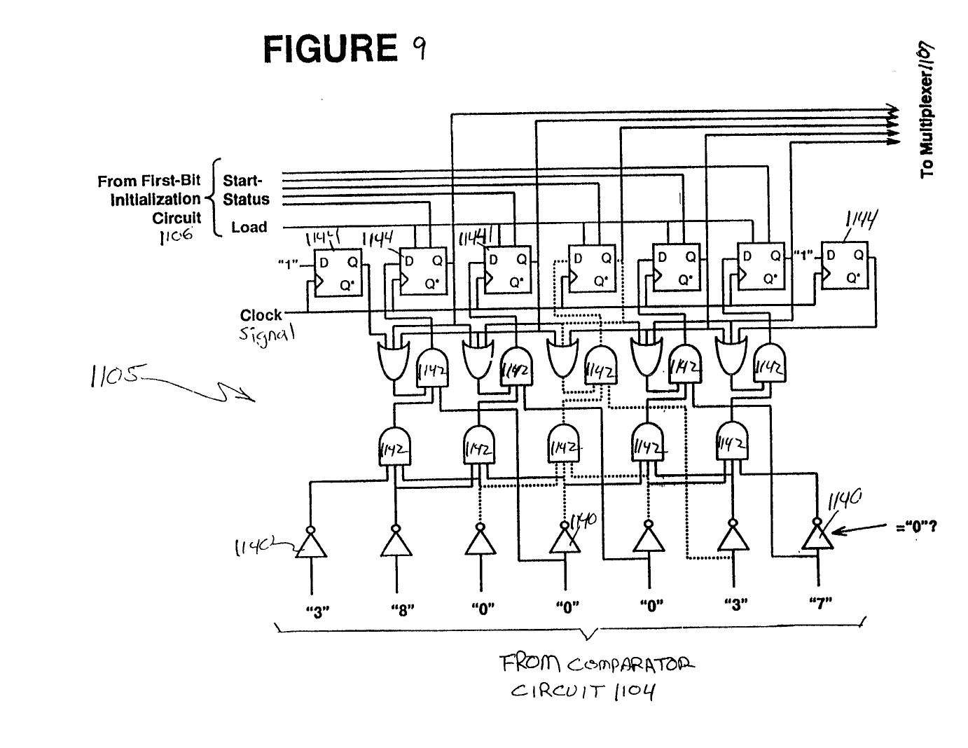

FIG. 9 is a simplified schematic diagram of a decision circuit 1105 which implements the decision algorithm described immediately above. The illustrated embodiment of circuit 1105 is formed by inverters 1140, logic And gates 1142, logic Or gates 1143, and D-type flip-flops 1144. As described in greater detail below, the decision circuit 1105 shown in FIG. 9 is also capable of being interfaced to the first-bit initialization circuit 1106. The dashed signal lines in FIG. 9 illustrate the “true” logic path that will cause the flip-flop output terminal 1118D to be selected by the multiplexer 1107 on the basis of the example bit samples and comparison sums shown in FIGS. 7-9. It is to be understood, however, that the decision algorithm and associated circuit described above are provided only for purposes of example. The function of the decision circuit 1105 can be implemented by other decision algorithms to meet the particular requirements, environment or other factors associated with the particular system in which the circuit 1100 is to be implemented. Also, the desired decision algorithm can be implemented by other circuit configurations.

The components of the data alignment circuit 1100 described above cause each and every bit of the Data signal bit stream to be sampled at several time slice locations, the adjacent time-slice samples to be compared and the optimum clock phase synchronized timeslice bit location to be selected by the multiplexer 1107 and used as the Data signal. The selected sampling location will generally be located prior to the start of the signal transition region. As the Data signal and Clock signal phases drift with respect to one another due to temperature variations or other factors, the circuit 1100 will continue to track the data stream and adjust accordingly.

The alignment circuit also offers the capability of having the circuit 1100 align the first bit as well as subsequent bits of a Data signal with the Clock signal. This function is enabled in the illustrated embodiment of circuit 1100 by the use of the Data Ready signal which is provided to the circuit in addition to the Data signal. The Data Ready signal is a signal which switches logic states at the time corresponding to the start of the incoming Data signal bit stream.

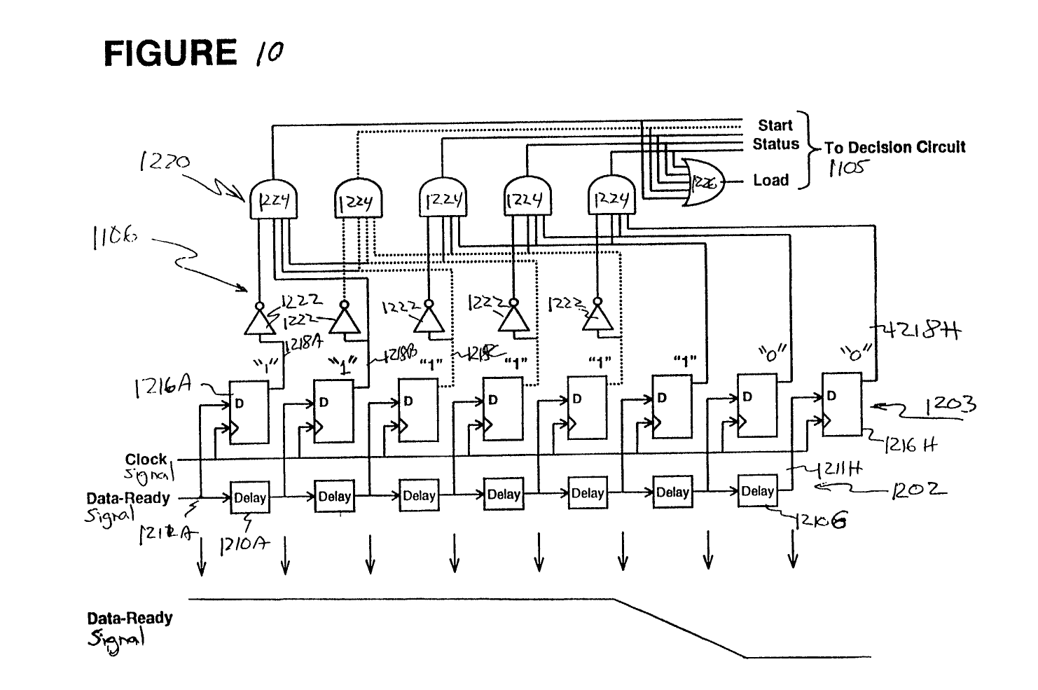

FIG. 10 is a schematic illustration of a first-bit initialization circuit 1106 which is configured to operate with a Data Ready signal of the type described above. The Data Ready signal is also shown in FIG. 10 in a form graphically “scaled” to the circuit 1106. In the illustrated embodiment the Data Ready signal switches from a logic “0” state to a logic “1” state with its rising edge identifying the start of the incoming data stream. The alignment circuit 1100 accepts the Data signal and phase synchronizes the Data signal to the Clock signal as long as the Data Ready signal is at the logic “1” state. When the Data Ready signal is at the logic “0” state (i.e., when no valid data is being transmitted), the data bit alignment circuit 1100 ignores the Data signal.

The first-bit initialization circuit 1106 shown in FIG. 10 includes a data ready signal delay circuit 1202 and data ready signal sampling circuit 1203. Delay circuit 1202 and sampling circuit 1203 are substantially similar to the data signal delay circuit 1102 and data signal sampling circuit 1102 described above and have components identified by corresponding reference numbers. Delay circuit 1202 and sampling circuit 1203 process the Data Ready signal in a manner similar to that by which the circuits 1102 and 1103, respectively, process the Data signal, and thereby produce Data Ready signal time-slice samples at the output terminals 1218A-1218H of the flip-flops 1216A-1216H, respectively.

The data ready time-slice samples on terminals 1218A-1218H are processed by an edge transition identification circuit 1220. In particular, the transition identification circuit 1220 processes the data ready time slice samples on the basis of a predetermined algorithm to identify the flip-flop output terminal 1218A-1218H on which the Data Ready signal edge transition occurs. The illustrated embodiment of edge transition identification circuit 1220 produces a Start Status signal representative of the flip-flop output terminal 1218A-218H on which the Data Ready signal edge transition was identified, and a Load signal indicating that the signal edge was identified. In the embodiment shown, the edge transition identification circuit is formed by inverters 1222, logic And gates 1224 and logic Or gate 1226 to implement a decision algorithm which effectively identifies the rising edge as the last time-slice sample having a logic “0” state before three adjacent time-slice sample locations having a logic “1” state. It is to be understood, however, that the transition identification decision algorithm and associated circuit described above are provided only for purposes of example. The function of the transition identification circuit 1220 can be implemented by other decision algorithms to meet the particular requirements, environment or other factors associated with the particular system in which the circuit 1100 is to be implemented. Also, the desired decision algorithm can be implemented by other circuit configurations. For example, the component count of the circuit 1106 can be generally reduced through the use of a toggling Data Ready signal which remains at a continuous logic “0” state during periods of time that the Data signal is not being transmitted, but toggles between a logic “1” and logic “0” state during every bit of the Data signal. Using a Data Ready signal of this type would facilitate the removal of the comparator circuit 1104, with the first-bit alignment circuit 1106 used to track the phase alignment of the Data and Clock signals with every transition of the Data Ready signal.

When the transition of a Data Ready signal is identified, first-bit initialization circuit 1106 causes the corresponding time-slice sample location to be loaded into the multiplexer 1107 (FIG. 6) through the decision circuit 1105 (FIG. 9). In particular, the Start Status signal and Load signal from the transition identification circuit 1220 are coupled to the flip-flops 1144 of the decision circuit 1105. On the next pulse of the Clock signal the flip-flops 1144 cause the identified edge transition time-slice sample location to be applied to the multiplexer 1107 as a first-bit select signal. The flip-flop output terminal 1118A-1118H associated with the time-slice location selected by the first-bit initialization circuit 1106 and decision circuit 1105 in the manner described above will be used by the data bit alignment circuit 1100 until the time-slice sample selection function is provided by circuits 1102, 1103, 1104 and 1105 in the manner described above.

The accuracy of the first-bit initialization function provided by the circuit 1106 described above is dependent upon the degree to which the transition of the Data Ready signal is phase aligned with the first data bit of the Data signal. Unlike the Clock signal which is typically distributed from a common source to several subsystems over separate paths, the Data Ready signal can be produced by the same subsystem which produced the Data signal and transmitted to the same subsystem as the Data signal over paths having characteristics similar to those over which the Data signal was transmitted. A relatively high degree of phase alignment between the Data Ready and Data signals, and therefore accuracy of the first-bit alignment function, can thereby be achieved by the present invention. Furthermore, although described in connection with a Data Ready signal, it is also possible to implement the first-bit alignment function using delay and logic circuits that process only the Data signal (e.g., do not make use of the Data Ready signal).

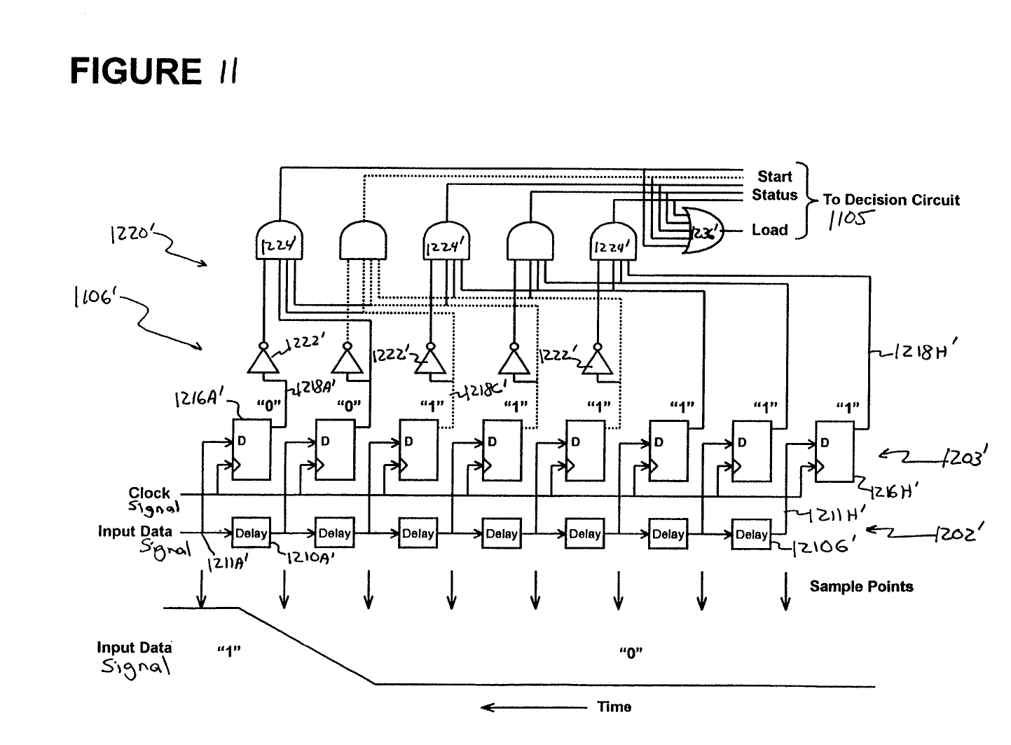

FIG. 11 is a schematic illustration of a first-bit initialization circuit 1106′ which is configured to operate without a Data Ready signal of the type described above. Circuit 1106′ is similar to circuit 1106 described above, and similar features are illustrated with similar reference numbers. The first-bit initialization circuit 1106′ shown in FIG. 11, however, uses a logic state transition (e.g., logic “0” to logic “1” in the illustrated embodiment) in the Data signal for purposes of causing the circuit 1100 to align the first as well as subsequent bits of a Data signal with the Clock signal. The Data signal is therefore effectively used to provide the initial bit initialization control function in this embodiment. Accordingly, the Data signal is applied to the delay circuit 1202′ (rather than the Data Ready signal applied to circuit 1202 in FIG. 6). One benefit of initialization circuit 1106′ is that it does not require the use of a separate Data Ready signal. However, for optimum performance of circuit 1106′, the Data signal should be held at the first or logic “0” state during periods that no valid data is being transmitted, and to transition to a second or logic “1” state at the first bit.

Although described above in connection with a single serial Data signal bit stream with a time-aligned Data Ready signal and asynchronous Clock signal, those skilled in the art will recognize that the data alignment circuit can be readily adapted for use in parallel Data signal applications, and at a reduced component count per bit. For example, in a parallel Data signal application a delay circuit such as 1102, sampling circuit such as 1103 and multiplexer such as 1107 can be incorporated into every bit path of the signal (word). However, only one comparator circuit such as 1104, decision circuit such as 1105 and initialization circuit such as 1106 need be incorporated into the alignment circuit for each parallel Data signal. An embodiment of this type operates on the basis that the phase skew between the Clock signal and all the bits of the parallel Data signal are substantially similar (for reasons similar to those described above with respect to the Data Ready and Data signals). The time-slice sample location selected by the circuits 1104, 1105 and 1106 can therefore be used to control the selection of the sample location for the remaining bits of the parallel Data signal, while maintaining a high degree of phase alignment accuracy for these remaining bits.

Although the present invention has been described with reference to preferred embodiments, those skilled in the art will recognize that changes can be made in form and detail without departing from the spirit and scope of the invention.

What is claimed is:

1. A parallel, point-to-point bus architecture for interconnecting two or more electronic components for data communication, comprising:
a non-blocking crosspoint switch having a tap for interconnection to each component;
a clock terminal for receiving a common clock signal;
an interface for connecting each component to a tap of the crosspoint switch, including:
parallel data terminals for coupling data signals between the crosspoint switch tap and the component;
a clock terminal for coupling the common clock signal between the crosspoint switch tap and the component; and
a clock-to-data alignment system for aligning the data signals coupled between the crosspoint switch tap and the component to the common clock signal.

2. The bus architecture of claim 1 wherein the clock-to-data alignment system includes first bit trigger capability.

3. The bus architecture of claim 1 and further including a clock reference to providing the common clock signal.

4. The bus architecture of claim 1 wherein:
the interfaces are connected directly to the crosspoint switch; and
the bus architecture further includes parallel buses for connecting the interfaces to the components.

5. The bus architecture of claim 1 and further including parallel buses for connecting the interfaces to the taps of the crosspoint switch.

6. A method for communicating data in a parallel format between a plurality of electronic components through one or more crosspoint switches, including:
distributing a common clock signal to the electronic components through the crosspoint switch;
transmitting first data signals from a first transmitting component to a first receiving component through the crosspoint switch; and
aligning the first data signals with the common clock signal at the first receiving component before sampling the first data signals.

7. The method of claim 6 and further including:
transmitting second data signals from a second transmitting component to a second receiving component through the crosspoint switch simultaneously with the transmission of the first data signals.

8. The method of claim 6 and further including transmitting handshaking protocol signals with the first data signals.

9. The method of claim 6 wherein aligning the first data signals with the common clock signal includes aligning the first bit of the data signals with the common clock signal.
